(19) United States
(12) Patent Application Publication
(10) Pub. No.: US 2023/0259704 A1
(43) Pub. Date: Aug. 17, 2023

(54) INFORMATION PROCESSING DEVICE, INFORMATION PROCESSING METHOD AND RECORDING MEDIUM

(71) Applicant: NEC Corporation, Minato-ku, Tokyo (JP)

(72) Inventor: Ayako HOSHINO, Tokyo (JP)

(73) Assignee: NEC Corporation, Minato-ku, Tokyo (JP)

(21) Appl. No.: 18/014,416

(22) PCT Filed: Jul. 6, 2020
(86) PCT No.: PCT/JP2020/026344

§ 371 Date: Jan. 4, 2023

(51) Int. Cl. G06F 40/258; G06F 40/56; G06F 40/103

(52) U.S. Cl. CPC G06F 40/258; G06F 40/56; G06F 40/103

(57) ABSTRACT

The information processing device generates headings from structured documents. The acquisition means acquires a structured document including headings and texts. The training data generation means generates training data including the heading as a label and subordinate elements of the heading as input data. The training means trains a generation model using the training data, wherein the generation model generates a heading from the subordinate elements. The heading generation means generates headings included in an objective document using the trained generation model.

### TECHNICAL FIELD

The present invention relates to a technique for applying headings to structured documents.

### BACKGROUND ART

In websites, there are systems such as a search engine which outputs search results against inputs of keywords by a user, and a so-called chatbot (Chatbot) which answers to a user's query statement (query). Such systems refer to structured documents on the Web associated with the inputted keywords and the query to generate the search results and/or answers. Patent Document 1 discloses a technique for structuring documents by their use. Also, Patent Document 2 discloses a technique for judging an implication relationship between a heading and text included in a structured document using machine learning.

### PRECEDING TECHNICAL REFERENCES

### Patent Document

Patent Document 1: Japanese Patent Application Laid-Open under No. JP 2009-294950

Patent Document 2: Japanese Patent Application Laid-Open under No. JP 2013-50853

### SUMMARY

### Problem to be Solved by the Invention

In order to generate appropriate search results and answers to user inputs, it is necessary that appropriate headings are given to the structured documents. However, if a heading is added by referring to tag information from a structured document such as HTML, for example, the heading may be simply a number or symbol indicating an order, or may be identical to other headings, and the information of the heading becomes insufficient.

It is an object of the present invention to provide an information processing device capable of generating appropriate headings based on subordinate headings and texts in a structured document.

### Means for Solving the Problem

According to an example aspect of the present invention, there is provided an information processing device comprising:

an acquisition means configured to acquire a structured document including headings and texts;

a training data generation means configured to generate training data including the heading as a label and subordinate elements of the heading as input data;

a training means configured to train a generation model using the training data, the generation model generating a heading from the subordinate elements; and

a heading generation means configured to generate headings included in an objective document using the trained generation model.

According to another example aspect of the present invention, there is provided an information processing method comprising:

acquiring a structured document including headings and texts;

generating training data including the heading as a label and subordinate elements of the heading as input data;

training a generation model using the training data, the generation model generating a heading from the subordinate elements; and

generating headings included in an objective document using the trained generation model.

According to still another example aspect of the present invention, there is provided a recording medium recording a program which causes a computer to execute processing of:

acquiring a structured document including headings and texts;

generating training data including the heading as a label and subordinate elements of the heading as input data;

training a generation model using the training data, the generation model generating a heading from the subordinate elements; and

generating headings included in an objective document using the trained generation model.

### Effect of the Invention

According to the present invention, it is possible to generate appropriate headings based on subordinate headings and texts in structured documents.

### BRIEF DESCRIPTION OF THE DRAWINGS

FIG. 1 shows an overall configuration of a heading generation device according to a first example embodiment.

FIG. 2 is an example of a hierarchical structure of a structured document.

FIG. 3 is another example of a structured document.

FIG. 4 shows an example where one heading is inappropriate in the structured document shown in FIG. 3.

FIG. 5 is a block diagram showing a hardware configuration of the heading generation device.

FIG. 6 is a block diagram showing a functional configuration of the heading generation device at the time of training.

FIG. 7 is a flowchart of training processing by the heading generation device.

FIG. 8 is a block diagram showing a functional configuration of the heading generation device at the time of generating headings.

FIG. 9 is a flowchart of heading generation processing by heading generation device.

FIG. 10 is a block diagram showing a functional configuration of an information processing device according to a second example embodiment.

FIG. 11 is a flowchart of heading generation processing in the second example embodiment.

### EXAMPLE EMBODIMENTS

Preferred example embodiments of the present invention will be described with reference to the accompanying drawings.

### First Example Embodiment

### [Overall Configuration]

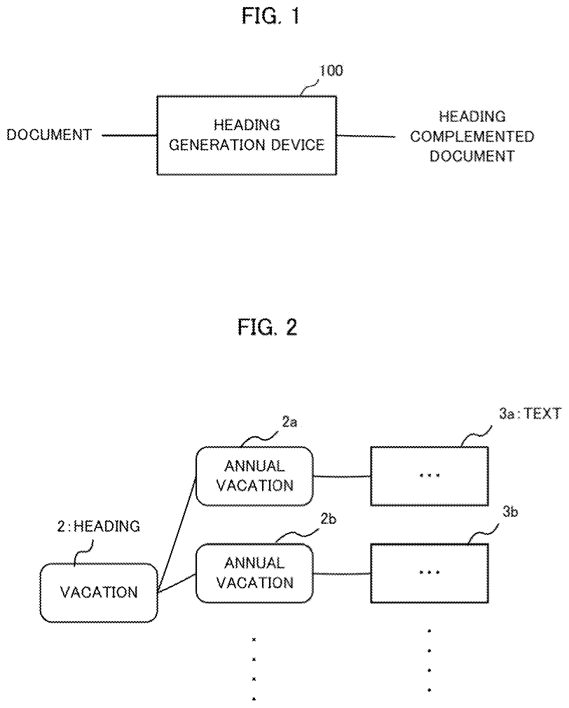

FIG. 1 shows an overall configuration of a heading generation device according to the first example embodiment. The heading generation device 100 outputs a heading complemented document in which appropriate headings are added to an inputted document. If the inputted document has already been structured, the heading generation device 100 determines whether or not the headings included in the structured document are appropriate and outputs a heading complemented document in which the headings determined to be inappropriate are corrected. On the other hand, if the inputted document is not structured, the heading generation device 100 first structures the inputted document, and then corrects the inappropriate headings to output the heading complemented document.

[Structured Document]

A structured documents is a document that marks up the structure of the document, and typically XML (eXtensible Markup Language) or HTML (Hyper Text Markup Language) are known as the structured document. In XML and HTML documents, the structure of the document is expressed by character strings called tags.

FIG. 2 shows an example of a hierarchical structure of a structured document. This document is an explanatory document of the term “Vacation” and includes headings 2, 2a, 2b, . . . and texts 3a, 3b. . . . The heading 2 is the heading at the highest level (the first level), and the headings 2a and 2b are the headings at the lower level (the second level). Each text 3a, 3b is a text corresponding to the heading 2a, 2b. In this structured document, both the headings 2a and 2b are “Annual Vacation” and have the same character strings. Therefore, when this structured document is used for search or browsing, there is a possibility that correct search results or answers cannot be outputted to the user's input regarding “Annual Vacation”. Thus, if the character string of the heading is identical to the character string of another heading in parallel relationship, those headings are inappropriate because they cannot be distinguished from each other. Also, even if the character strings of the headings are not identical, if the character strings of the headings are similar or if the character string of one heading implies the meaning of the character string of the other heading, the headings are considered to be inappropriate.

In addition, the heading is inappropriate if the character string of the heading does not have sufficient meaning. The headings are considered to be inappropriate when each heading does not have a specific meaning, for example, when the character strings of the headings are merely numbers or symbols such as “1.”, “2.”, “(a) and “(b)”, or when the character strings of the headings merely indicate the order of sections such as “Chapter 1” and “Chapter 2”.

When the headings of the structured document are inappropriate, the output for the user's search and browsing may be inappropriate. Therefore, the heading generation device 100 detects inappropriate headings in the structured document and corrects them to be appropriate.

[Method of Generating Headings]

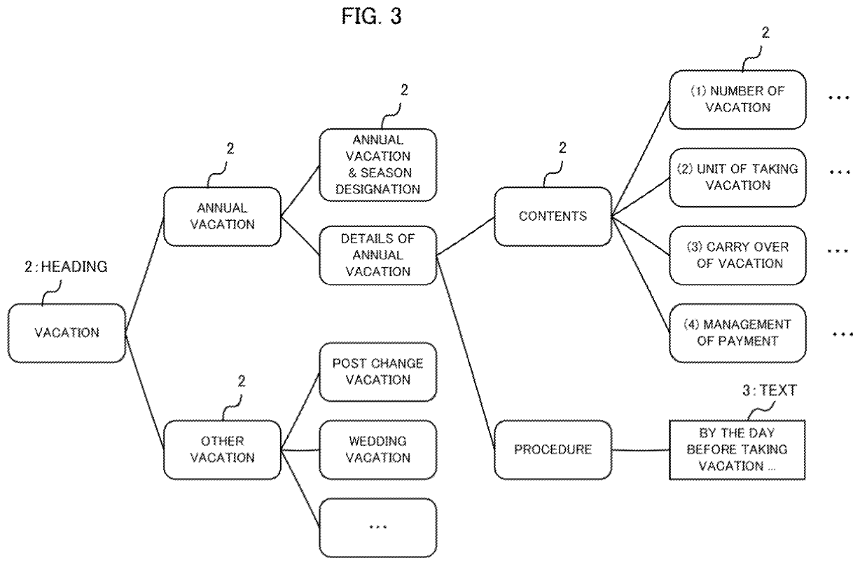

FIG. 3 shows another example of a structured document. This example is also a structured document regarding the term “Vacation” and includes a hierarchical structure of multiple headings 2 and texts 3. In FIG. 3, for convenience, some headings and texts are not shown.

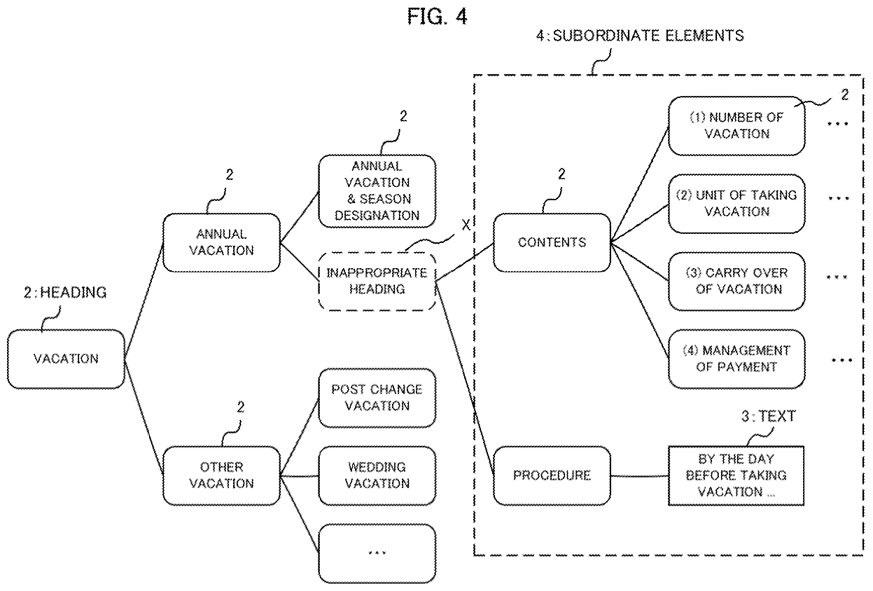

FIG. 4 shows the case where one heading is inappropriate in the structured document shown in FIG. 3. As shown in FIG. 4, if the heading X is inappropriate, heading generation device 100 generates a new heading instead of the inappropriate heading X. Specifically, the heading generation device 100 generates a new heading to replace the inappropriate heading X based on the subordinate elements 4 of the inappropriate heading X. Here, the subordinate elements 4 includes at least one of the headings (the subordinate headings) 2 and the texts 3 existing in the lower hierarchy of the inappropriate heading X.

In detail, the heading generation device 100 trains a heading generation model by supervised learning using the headings in the structured document and the subordinate elements of the headings, and generates a new heading using the trained heading generation model. Specifically, at the time of learning, the heading generation device 100 generates training data in which each heading in the structured document is used as a label (correct label) and the subordinate elements of the heading are used as input data for training (hereinafter, also referred to as “training input data”). In the example of the structured document shown in FIG. 3, the heading generation device 100 generates the training data using the heading “Vacation” as a label and using its subordinate elements as the training input data. Also, for each of the other headings included in the structured document of FIG. 3, the heading generation device 100 generates training data including the heading as a label and the subordinates of the heading as training input data. Thus, the heading generation device 100 generates a set of the label and the training input data for each heading contained in the structured document.

In this case, the heading generation device 100 generates a plurality of training data using all or a part of the plurality of headings 2 and texts 3 included in the subordinate elements of each heading as the training input data. For example, for the heading “Annual Vacation” in FIG. 3, all the subordinate elements may be used as the input data for one training, and a part of them (for example, only the subordinate elements of the heading “Details of Annual Vacation”) may be used as the input data for one training.

Thus, the heading generation device 100 trains the heading generation model which generates, when a subordinate element in inputted, a heading corresponding to the inputted subordinate element. Then, when the training of the heading generation model is completed, the heading generation device 100 generates new headings that replace inappropriate headings in the structured document using the trained heading generation model. This allows the heading generation device 100 to correct inappropriate headings in the structured document and output heading complemented documents.

[Hardware Configuration]

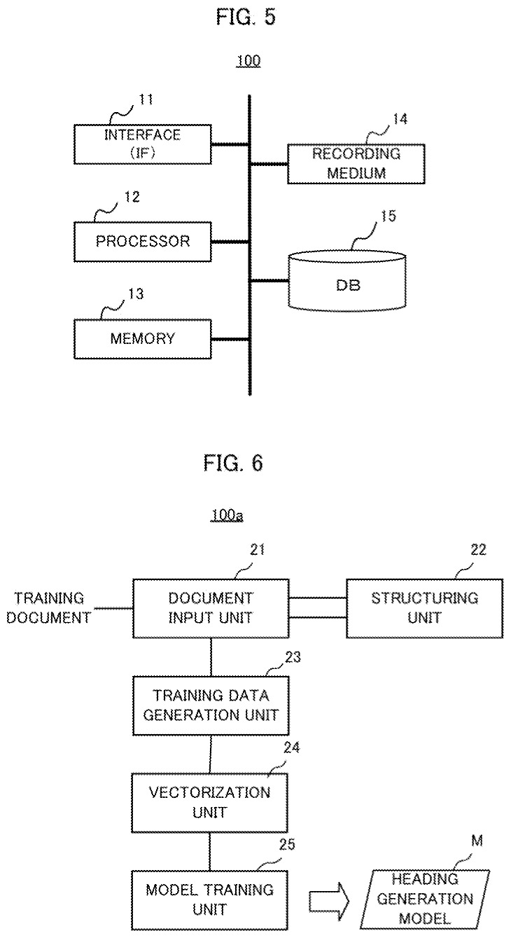

FIG. 5 is a block diagram showing a hardware configuration of the heading generation device 100. As shown, the heading generation device 100 includes an interface (IF) 11, a processor 12, a memory 13, a recording medium 14, and a data base (DB) 15.

The IF 11 inputs and outputs data to and from external devices. Specifically, the documents used for training the heading generation model and the documents subject to the heading generation processing are inputted through the IF 11. In addition, the heading complemented document whose inappropriate headings are corrected by the heading generation device 100 is outputted to an external device through the IF 11.

The processor 12 is a computer such as a CPU (Central Processing Unit) or a GPU (Graphics Processing Unit) and controls the entire heading generation device 100 by executing a program prepared in advance. Specifically, the processor 12 executes the training processing and the heading generation processing to be described later.

The memory 13 may be a ROM (Read Only Memory) and a RAM (Random Access Memory). The memory 13 is also used as a working memory during the execution of various processing by the processor 12.

The recording medium 14 is a non-volatile and non-transitory recording medium such as a disk-type recording medium, a semiconductor memory, or the like, and is configured to be detachable from the heading generation device 100. The recording medium 14 records various programs executed by the processor 12. When the heading generation device 100 performs various processing, the program recorded in the recording medium 14 is loaded into the memory 13 and executed by the processor 12.

The database 15 temporarily stores the documents inputted through the IF 11 and the training data used in the training processing of the heading generation model, and the like. The heading generation device 100 may include a keyboard, an input unit such as a mouse, and a display unit such as a liquid crystal display for the user's instruction and input.

[Configuration at the Time of Training]

FIG. 6 is a block diagram illustrating a functional configuration of the heading generation device at the time of training. The heading generation device 100a at the time of training trains the heading generation model M and outputs the trained heading generation model M. The heading generation device 100a includes a document input unit 21, a structuring unit 22, a training data generation unit 23, a vectorizing unit 24, and a model training unit 25.

To the document input unit 21, documents used for training the heading generation model M (hereinafter, also referred to as “training documents”) are inputted. The training documents are used to generate training data for use in training the heading generation model M. When the training document inputted to the document input unit 21 is a structured document, i.e., a document that has already been structured, the document input unit 21 outputs the document to the training data generation unit 23. On the other hand, when the training document is a non-structured document (unstructured document), the document input unit 21 outputs the inputted document to the structuring unit 22 and receives the structured document from the structuring unit 22. Then, the document input unit 21 outputs the structured document to the training data generation unit 23.

The structuring unit 22 structures the inputted unstructured document, and outputs the structured document to the document input unit 21 as the structured document. For example, the structuring unit 22 performs processing of extracting the character string corresponding to the heading in the inputted unstructured document and putting a tag to the character string. Thus, the structuring unit 22 generates the structured document and outputs it to the document input unit 21.

The training data generation unit 23 generates the training data for training the heading generation model M using the structured document. Specifically, the training data generation unit 23 selects one heading in the inputted structured document and identifies the subordinate elements of the heading. In the example of FIG. 3, when generating the training data for the heading “Annual Vacation”, the training data generation unit 23 uses the heading “Annual Vacation” as the label, and uses the subordinate elements of the heading “Annual Vacation”, i.e., the headings and the texts existing below, i.e., in the lower layer of the heading “Annual Vacation” as the training input data. Then, the training data generation unit 23 generates a pair of the label and the training input data as the training data. Thus, the training data generation unit 23 generates the training data for each heading included in the structured document. The training data generation unit 23 outputs the generated training data to the vectorizing unit 24.

Incidentally, the training data generation unit 23 can use any combination of a plurality of headings and texts that exist below the objective heading as the training input data. That is, when generating the training data for a certain heading, the training data generation unit 23 may use all the subordinate elements below the heading as the training input data, and may use the subordinate elements from which a part of them is excluded as the training input data. In other words, for a certain heading, the training data generation unit 23 may use only the lower nodes directly below the heading (i.e., the nodes of one-level lower) as the training input data, or may use the group of the lower nodes below the heading (i.e., the nodes at the certain level(s) or all the levels in the hierarchy) as the training input data. By this, the number of training data used for training may be increased.

Incidentally, it is desirable that the training data generation unit 23 excludes, from the training data, any heading that does not have a specific meaning, for example, the heading that is a character string of only a number and a symbol such as “1.”, “2.”, “(a)”, and “(b)”, or the heading that simply indicates the order of sections likes “Chapter 1”, “Chapter 2”, among the headings included in the structured document. Thus, the heading generation model M is trained to be able to generate appropriate upper headings based on the subordinate elements.

The vectorization unit 24 vectorizes the inputted training data, i.e., the label and the training input data. As mentioned above, the label is the heading and the training input data is the subordinate elements of the heading corresponding to the label. The vectorizing unit 24 expresses the heading which is a label, and the subordinate headings and texts which form the subordinate elements by vectors of a predetermined dimension using a word distributed representation or a word embedding. The examples of the word distributed representation or the word embedding are Word2vec, Doc2vec, BERT (Bidirectional Encoder Representations from Transformers), and fastText. Instead of the method using the pre-trained model as described above, the documents may be vectorized using a simple model such as a Bag of Words. Then, the vectorization unit 24 generates a fixed length vector for use in the model training unit 25 by the method of concatenating vectors obtained from the headings and the texts, calculating a linear sum of the vectors, or synthesizing the vectors using a recursive neural network. The vectorization unit 24 outputs the vectorized teaching data to the model training unit 25.

The model training unit 25 acquires the vectorized training data and performs training of the heading generation model M. The model training unit 25 is constituted by, for example, a neural network or the like, and trains the heading generation model M by deep learning. Specifically, the model training unit 25 inputs the vectorized training input data to the heading generation model M and updates the parameters of the neural network constituting the heading generation model M on the basis of the loss between the output and the vectorized label. Then, the model training unit 25 ends the training when the loss between the output of the heading generation model M and the label converges to the predetermined range, and outputs the heading generation model M at that time as the trained heading generation model M.

In this way, by generating the training data from the structured documents for training and training the heading generation model M, it is possible to obtain a heading generation model M capable of generating an appropriate upper heading based on the subordinate elements.

In the above-described configuration, the document input unit 21 is an example of an acquisition means, the structuring unit 22 is an example of a structuring means, the training data generation unit 23 is an example of a training data generation means, the vectorizing unit 24 is an example of a vectorizing means, and the model training unit 25 is an example of a training means.

[Training Processing]

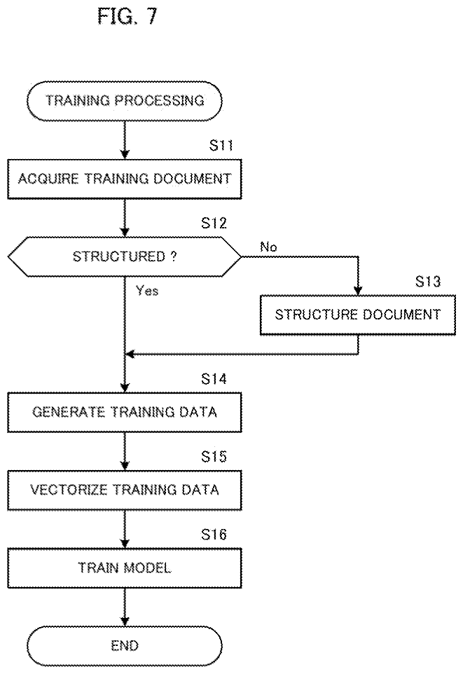

FIG. 7 is a flowchart of training processing executed by the heading generation device 100a at the time of training. This processing is realized by the processor 12 shown in FIG. 5, which executes a pre-prepared program and operates as each element shown in FIG. 6.

First, the document input unit 21 acquires the training document (step S11), and determines whether or not the training document is structured (step S12). If the inputted training document is structured (step S12: Yes), the document input unit 21 outputs the training document to the training data generation unit 23. On the other hand, when the inputted training document is not structured (step S12: No), the document input unit 21 outputs the training document to the structuring unit 22, and the structuring unit 22 structures the training document (step S13). Then, the structuring unit 22 outputs the structured training document to the document input unit 21, and the document input unit 21 outputs the structured training document to the training data generation unit 23.

The training data generation unit 23 generates pairs of the heading and the subordinate elements of the heading from the inputted training document and sets the pairs as the training data (step S14). Thus, the training data that are the pairs of each heading and its subordinate elements contained in the structured training document are generated. Next, the vectorization unit 24 vectorizes the labels and the training input data constituting the training data, i.e., the headings and the subordinate elements of the heading, respectively, and outputs the vectorized data to the model training unit 25 (step S15).

The model training unit 25 trains the heading generation model M using the vectorized training data and outputs the heading generation model M as the trained model M at the time when the predetermined convergence condition is satisfied (step S16). Then, the training processing ends.

[Configuration at the Time of Generating Headings]

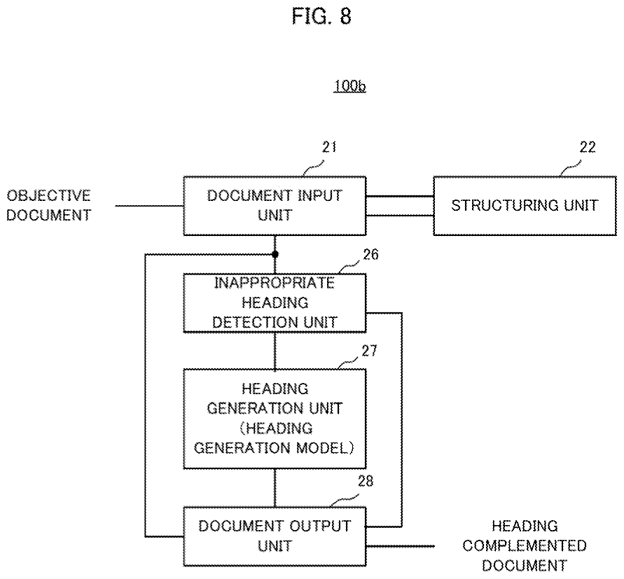

Next, the configuration at the time of generating headings by the heading generation device will be described. FIG. 8 illustrates the functional configuration of the heading generation device 100b at the time of generating headings using the trained heading generation model M. The heading generation device 100b at the time of generating headings includes a document input unit 21, a structuring unit 22, an inappropriate heading detection unit 26, a heading generation unit 27, and a document output unit 28. The document input unit 21 and the structuring unit 22 are basically the same as those in the heading generation device 100a at the time of training.

At the time of generating headings, a document (hereinafter, referred to as “objective document”) that is subjected to the heading generation is inputted to the document input unit 21. When the objective document is a structured document, the document input unit 21 outputs the objective document to the inappropriate heading detection unit 26. On the other hand, when the objective document is a document that is not structured, the document input unit 21 outputs the objective document to the structuring unit 22. The structuring unit 22 structures the inputted objective document and inputs the structured objective document to the document input unit 21, and the document input unit 21 outputs the structured objective document to the inappropriate heading detection unit 26.

The inappropriate heading detection unit 26 identifies a point in the inputted objective document where the generation of the heading is required. Specifically, the inappropriate heading detection unit 26 extracts the heading corresponding to the aforementioned inappropriate heading from the headings included in the objective document. Then, the inappropriate heading detection unit 26 outputs the subordinate elements of the inappropriate heading to the heading generation unit 27. Also, the inappropriate heading detection unit 26 outputs information indicating the position of the inappropriate heading in the objective document to the document output unit 28.

The heading generation unit 27 inputs the subordinate elements of the inappropriate heading to the trained heading generation model M and generates a new heading. In the example of FIG. 4, the heading generation unit 27 inputs the subordinate elements 4 of the inappropriate heading X indicated by the broken line to the heading generation model M as the input data. At this time, the heading generation unit 27 vectorizes the subordinate elements 4 of the inappropriate heading X by the same method as that of the vectorizing unit 24 at the time of training, and inputs the vectors to the heading generating model M. The heading generation model M generates a new heading based on the input data and outputs the new heading to the document output unit 28.

The document output unit 28 acquires information indicating the position of the inappropriate heading from the inappropriate heading detection unit 26 and acquires the new heading generated by the heading generation unit 27. Then, the document output unit 28 corrects the inappropriate heading in the objective document using the new heading and outputs the objective document as the heading complemented document. As a first method of correcting the inappropriate heading, the document output unit 28 replaces the inappropriate heading with the new heading. That is, instead of the inappropriate heading, the new heading is used.

As a second method of correcting the inappropriate heading, the document output unit 28 adds the new heading to the inappropriate heading. For example, in the case of FIG. 2, both the headings 2a and 2b are “Annual Vacation” and are inappropriate because they are the same heading. Now, if a new heading “Conditions to take annual vacation” is created for the heading 2a and a new heading “How to apply annual vacation” is created for the heading 2b, the document output unit 28 modifies the heading 2a as “Annual Vacation (Conditions to take)” and modifies the heading 2b as “Annual Vacation (How to apply)”. As such, the document output unit 28 may correct the inappropriate heading by adding a new heading.

In this way, the heading generation device 100b can correct inappropriate headings included in the objective document and output the objective document as a heading complemented document. Further, according to the heading generation device 100b, even when the objective document is not structured, appropriate headings can be given after the objective document is structured by the structuring unit 22.

In the above-described configuration, the inappropriate heading detection unit 26 and the heading generation unit 27 are examples of the heading generation means, and the document output unit 28 is an example of the document correcting means.

[Heading Generation Processing]

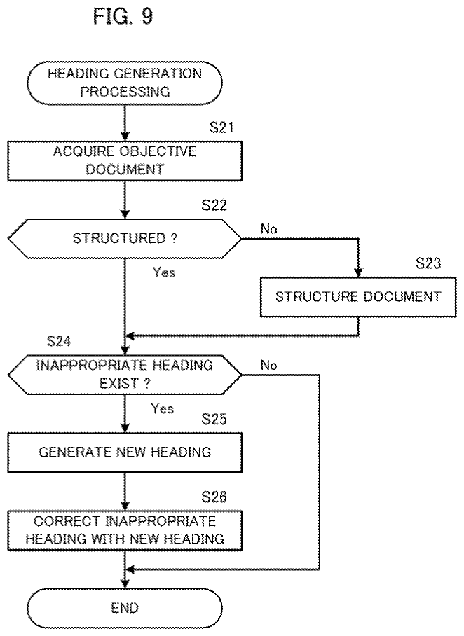

FIG. 9 is a flowchart of heading generation processing executed by the heading generation device 100b. This processing is realized by the processor 12 shown in FIG. 5, which executes a pre-prepared program and operates as each element shown in FIG. 8.

First, the document input unit 21 acquires an objective document (step S21) and determines whether or not the objective document is structured (step S22). When the inputted objective document is structured (step S22: Yes), the document input unit 21 outputs the objective document to the inappropriate heading detection unit 26. On the other hand, when the inputted objective document is not structured (step S22: No), the document input unit 21 outputs the objective document to the structuring unit 22, and the structuring unit 22 structures the objective document (step S23). Then, the structuring unit 22 outputs the structured objective document to the document input unit 21, and the document input unit 21 outputs the structured objective document to the inappropriate heading detection unit 26.

The inappropriate heading detection unit 26 determines whether or not one or more inappropriate headings are included in the inputted objective document (step S24). When the objective document does not include any inappropriate heading (step S24: No), the processing ends. On the other hand, when the objective document includes one or more inappropriate headings (step S24: Yes), the heading generation unit 27 vectorizes the subordinate elements of the inappropriate headings and inputs them to the trained heading generation model M to generate new headings (step S25). Next, the document output unit 28 corrects the inappropriate headings in the objective document using the new headings and outputs the heading complemented document (step S26). Then, the heading generation processing ends.

[Modification]

In the heading generation processing illustrated in FIG. 9, the heading generation device 100b corrects the inappropriate headings using the new headings generated in step S25. However, before using the new headings to correct the inappropriate headings, the heading generation device 100b may determine whether each of the new headings is appropriate or not, i.e., whether or not each of the new headings is differentiated from other headings included in the objective document. For example, when the new heading generated by the heading generation unit 27 is in the same or similar or implicit relationship with another heading in the same hierarchical level in the objective document, the document output unit 28 may reject the heading and use another heading generated by the heading generation unit 27. In this case, the document output unit 28 may compare the character strings of the headings to determine whether or not the new heading is appropriate, or may determine whether or not the new heading is appropriate based on the degree of similarity or distance between the vectors of the headings obtained by word distributed representation.

### Second Example Embodiment

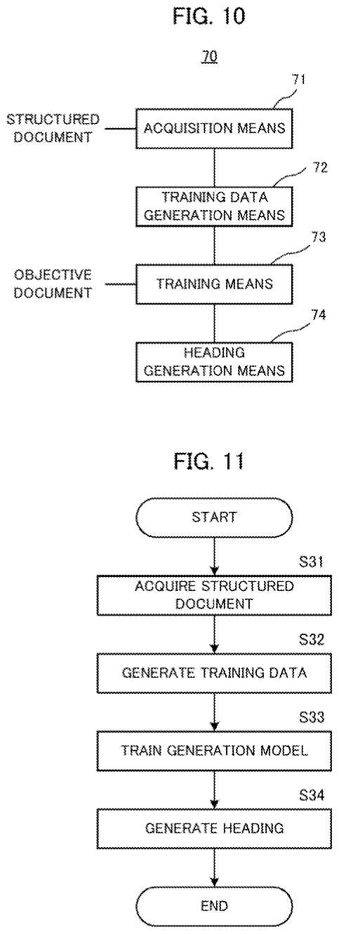

Next, a second example embodiment of the present invention will be described. FIG. 10 is a block diagram illustrating a functional configuration of an information processing device according to the second example embodiment. The information processing device 70 includes an acquisition means 71, a training data generation means 72, a training means 73, and a heading generation means 74. The acquisition means 71 acquires a structured document including headings and texts. The training data generation means 72 generates training data including the heading as a label and subordinate elements of the heading as input data. The training means 73 trains a generation model using the training data, wherein the generation model generates a heading from the subordinate elements. The heading generation means 74 generates headings included in an objective document using the trained generation model.

FIG. 11 is a flowchart of heading generation processing in the second example embodiment. The acquisition means 71 acquires a structured document including headings and texts (step S31). Next, the training data generation means 72 generates training data including the heading as a label and subordinate elements of the heading as input data (step S32). Next, the training means 73 trains a generation model using the training data, wherein the generation model generates a heading from the subordinate elements (step S33). Then, the heading generation means 74 generates headings included in an objective document using the trained generation model (step S34).

According to the information processing device 70 of the second example embodiment, the training data is generated from the structured document, and the generation model that generates appropriate headings from the subordinate elements is trained. Therefore, the information processing device 70 can generate appropriate headings for the objective document using the trained generation model.

A part or all of the example embodiments described above may also be described as the following supplementary notes, but not limited thereto.

(Supplementary Note 1)

An information processing device comprising:

an acquisition means configured to acquire a structured document including headings and texts;

a training data generation means configured to generate training data including the heading as a label and subordinate elements of the heading as input data;

a training means configured to train a generation model using the training data, the generation model generating a heading from the subordinate elements; and

a heading generation means configured to generate headings included in an objective document using the trained generation model.

(Supplementary Note 2)

The information processing device according to Supplementary note 1, further comprising a vectorization means configured to vectorize the training data,

wherein the generating model is a model using a neural network, and

wherein the training means trains the heading generation model using the vectorized training data.

(Supplementary Note 3)

The information processing device according to Supplementary note 1 or 2, wherein the subordinate elements include subordinate headings below the heading in the structured document, and texts below the heading.

(Supplementary Note 4)

The information processing device according to any one of Supplementary notes 1 to 3, wherein the heading generation means detects an inappropriate heading from the headings included in the objective document and generates a new heading for the inappropriate heading using the trained generation model.

(Supplementary Note 5)

The information processing device according to Supplementary note 4, further comprising a document correction means configured to generate a modified document by replacing the inappropriate heading in the objective document with the new heading.

(Supplementary Note 6)

The information processing device according to Supplementary note 4, further comprising a document correction means configured to generate a modified document by adding at least a part of the new heading to the inappropriate heading in the objective document.

(Supplementary Note 7)

The information processing device according to any one of Supplementary notes 4 to 6, wherein the inappropriate heading is a heading of a character string identical to another heading in a parallel relationship in the objective document.

(Supplementary Note 8)

The information processing device according to any one of Supplementary notes 4 to 6, wherein the inappropriate heading includes a number or a symbol without meaning or content.

(Supplementary Note 9)

The information processing device according to any one of Supplementary notes 1 to 8, further comprising a structuring means configured to convert an inputted document into the structured document.

(Supplementary Note 10)

An information processing method comprising:

acquiring a structured document including headings and texts;

generating training data including the heading as a label and subordinate elements of the heading as input data;

training a generation model using the training data, the generation model generating a heading from the subordinate elements; and

generating headings included in an objective document using the trained generation model.

(Supplementary Note 11)

A recording medium recording a program which causes a computer to execute processing of:

acquiring a structured document including headings and texts;

generating training data including the heading as a label and subordinate elements of the heading as input data;

training a generation model using the training data, the generation model generating a heading from the subordinate elements; and

generating headings included in an objective document using the trained generation model.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

2 Heading

3 Text

12 Processor

21 Document input unit

22 Structuring unit

23 Training data generation unit

24 Vectorization unit

25 Model training unit

26 Inappropriate heading detection unit

27 Heading generation unit

28 Document output unit

What is claimed is:

1. An information processing device comprising:
a memory configured to store instructions; and
one or more processors configured to execute the instructions to:
acquire a structured document including headings and texts;
generate training data including the heading as a label and subordinate elements of the heading as input data;
train a generation model using the training data, the generation model generating a heading from the subordinate elements; and
generate headings included in an objective document using a trained generation model.

2. The information processing device according to claim 1,
wherein the one or more processors are further configured to vectorize the training data,
wherein the generating model is a model using a neural network, and
wherein the one or more processors train the heading generation model using the vectorized training data.

3. The information processing device according to claim 1, wherein the subordinate elements include subordinate headings below the heading in the structured document, and texts below the heading.

4. The information processing device according to claim 1, wherein the one or more processors detect an inappropriate heading from the headings included in the objective document and generate a new heading for the inappropriate heading using the trained generation model.

5. The information processing device according to claim 4, wherein the one or more processors are further configured to generate a modified document by replacing the inappropriate heading in the objective document with the new heading.

6. The information processing device according to claim 4, wherein the one or more processors are further configured to generate a modified document by adding at least a part of the new heading to the inappropriate heading in the objective document.

7. The information processing device according to claim 4, wherein the inappropriate heading is a heading of a character string identical to another heading in a parallel relationship in the objective document.

8. The information processing device according to claim 1, wherein the inappropriate heading includes a number or a symbol without meaning or content.

9. The information processing device according to claim 1, wherein the one or more processors are further configured to convert an inputted document into the structured document.

10. An information processing method comprising:
acquiring a structured document including headings and texts;
generating training data including the heading as a label and subordinate elements of the heading as input data;
training a generation model using the training data, the generation model generating a heading from the subordinate elements; and
generating headings included in an objective document using a trained generation model.

11. A non-transitory computer-readable recording medium recording a program which causes a computer to execute processing of:
acquiring a structured document including headings and texts;
generating training data including the heading as a label and subordinate elements of the heading as input data;
training a generation model using the training data, the generation model generating a heading from the subordinate elements; and
generating headings included in an objective document using a trained generation model.
